(19) United States
(12) Patent Application Publication
(10) Pub. No.: US 2023/0392995 A1
(43) Pub. Date: Dec. 7, 2023

(54) METHOD FOR DETERMINING THE TEMPERATURE OF A RUBBERY MATERIAL ENTERING INTO THE COMPOSITION OF A TIRE

(71) Applicant: Compagnie Generale Des Etablissements Michelin, Clarmont-Ferrand (FR)

(72) Inventor: Aurélien MONTOY, Clermont-Ferrand (FR)

(73) Assignee: Compagnie Generale Des Etablissements Michelin, Clermont-Ferrand (FR)

(21) Appl. No.: 18/039,790

(22) PCT Filed: Nov. 26, 2021
(86) PCT No.: PCT/FR2021/052100

§ 371 Date: Jun. 1, 2023

(30) Foreign Application Priority Data
Dec. 7, 2020 (FR) FR2012765

(51) Int. Cl. G01K 11/00; G01B 11/06; B29D 30/06

(52) U.S. Cl. CPC G01K 11/006; G01B 11/0625; B29D 30/0662; B29D 2030/0675

(57) ABSTRACT

The method includes the step of positioning the product to be measured on a transport table. The method proceeds with the step of advancing the product under a frame that includes at least one terahertz sensor. The method continues with the step of emitting incident terahertz radiation in the direction of the product. The method proceeds with the step of detecting the signal corresponding to a multiple spectrum of terahertz rays reflected by the interfaces encountered by the incident ray. The method continues with the step of analyzing the signal to determine various peaks corresponding to the various interfaces encountered. The method proceeds with the step of determining, on the basis of the amplitude of each peak, the temperature of each layer of material through which the incident ray passes.

### CROSS-REFERENCE TO RELATED APPLICATIONS

This application claims priority to and the benefit of PCT Patent Application No. PCT/FR2021/052100 filed on 26 Nov. 2021, entitled “METHOD FOR DETERMINING THE TEMPERATURE OF A RUBBERY MATERIAL ENTERING INTO THE COMPOSITION OF A TYRE”, and French Patent Application No. FR2012765, filed on 7 Dec. 2020, entitled “METHOD FOR DETERMINING THE TEMPERATURE OF A RUBBERY MATERIAL ENTERING INTO THE COMPOSITION OF A TYRE”.

### BACKGROUND

### 1. Field

The present disclosure relates to the field of tire manufacturing. More specifically, the present invention relates to the management, monitoring and control of manufacturing methods, in particular as regards the temperature of the rubber products forming a tire.

### 2. Related Art

A tire manufacturing method comprises several major phases:
a phase of preparation of the semi-finished products used in the composition of a tire,
a phase of assembling these products according to an architecture initially defined by the designers, and
a phase of curing, also called vulcanization, of the assembly thus formed.

For optimum management of the preparation and assembly phases, it is useful to take temperature measurements during the different steps. This temperature measurement may be performed on a simple product, comprising a single layer, or on a complex product consisting of the assembly of various layers. These measurements are currently performed by a method of pricking the uncured rubber. Although simple to implement, this method does not guarantee sufficient measurement precision. To be specific, as the method is carried out manually, it is subject to many parameters which are difficult to control, including: the pricking depth (an incorrect depth leads to the measurement of an incorrect layer in the case of a complex product), a pricking time which may vary from one measurement to another, and an interpretation of the value which may vary from one operator to another.

In order to remedy these drawbacks, the quality managers responsible for manufacturing methods have implemented safety margins, which reduce production performance.

Moreover, to ensure control of the entire manufacturing method, temperature measurements are also performed at the end of the line, in other words on the tire after curing. Such a measurement is currently performed by inserting a thermocouple into the cured rubber, which results in damage to, or even destruction of, the product on which the measurement is performed.

### SUMMARY

The present disclosure therefore aims to remedy these drawbacks by proposing an accurate and non-invasive method for measuring the temperature of at least one layer of a multilayer polymer material.

In one particular embodiment, the disclosure will propose a method making it possible to determine the temperature of the various layers of rubber material of a tire, during any phase of manufacture.

Thus, the disclosure relates to a method for determining the temperature of at least one layer of a multilayer polymer product The method comprises the following steps:
positioning the product to be measured on a transport table,
advancing the product under a frame comprising at least one terahertz sensor,
emitting incident terahertz radiation (scanning part of the terahertz spectrum) in the direction of the product,
detecting the signal corresponding to a multiple spectrum (frequency scan, depending on the type of product) of terahertz rays reflected by the interfaces encountered by the incident ray,
analyzing the signal to determine various peaks corresponding to the various interfaces encountered, and
determining, on the basis of the amplitude of each peak, the temperature of each layer of material through which the incident ray passes.

The terahertz radiation is emitted at several frequencies by a scanning system for the desired spectrum. Advantageously, emission is performed with an incidence perpendicular, or substantially perpendicular, to the product. Also advantageously, this emission is performed in the focal plane.

This spectrum is chosen according to the absorption of the materials to be analysed, the desired precision and the thickness of the sample.

The terahertz wave emitted is partially returned by each product interface it encounters. Each of the returned signals is analyzed to deduce two pieces of information: the speed of propagation of the wave and the attenuation of the wave.

To be specific, the shape of the wave received may be modelled in a complex form n=n′+i*n″, where
n is the amplitude of the THz wave returned for each interface,
n′ is the Real part of the THz wave (refractive index), representing the speed of propagation which makes it possible to determine the thickness of the layer by measuring the propagation time of the wave, and
n″ is the Imaginary part of the wave representing the attenuation of the THz wave (absorption coefficient).

However, it has been found, surprisingly, that the variation in temperature of a sample changes the amplitude of the terahertz wave while keeping the propagation time stable.

Consequently, the analysis of the various peaks of the signal makes it possible to determine the temperatures of the various media encountered.

It is specified here that the variation in amplitude differs (shape, progression, etc.) from one rubber family to another. It is therefore useful to create charts for each type of family. A chart is created from a rubber sample instrumented with a thermocouple probe. The sample is then heated, then cooled naturally in air. During these two phases, the chart may be created by correlating the Terahertz data and the Thermocouple data.

On the basis of these data, it is therefore possible to determine the temperature of a single- or multilayer sample from a previously defined chart and the amplitude of the outbound interface.

It is specified here that, in order to be able to determine temperature, it is necessary to know the refractive index of the support.

Thus, a method according to the disclosure makes it possible to take an accurate and non-invasive temperature measurement. This measurement may be performed on any type of product, whatever the condition thereof.

Thus, in one embodiment, the multilayer polymer product is a product made up of several layers of rubber material, before or after curing. Furthermore, the product is advantageously a tire, a caterpillar track or a conveyor belt. It may nevertheless be used for any product made up of one or more layers of polymer material, and more preferably elastomer material. It may also be applied to such a product further comprising metal or textile reinforcing elements.

As this measurement is performed automatically, it is therefore not subject to the dispersion of measurements performed manually. Such a method therefore makes it possible to obtain more reliable measurements, and to reduce safety margins guaranteeing the quality of the finished products. The use of this method therefore makes it possible to achieve better production efficiency, both by increasing the production rate and by reducing non-compliant products.

In one advantageous embodiment, a method according to the disclosure comprises a step of processing the raw signal before the analysis step.

In one advantageous embodiment, the speed at which the product advances is between 0 and 70 meters per minute.

In one advantageous embodiment, the acquisition rate of the terahertz sensor is greater than 100 Hz.

The disclosure also relates to a method for determining the characteristics of at least one layer of a multilayer polymer product, the method comprising all the steps of a temperature determination method according to one of the above embodiments, and further comprising a step of determining, as a function of the difference between two peaks of the signal, the thickness of each layer of material through which the incident ray passes.

To be specific, it has been found that when an incident terahertz ray reaches a layer of polymer material, the characteristics of the reflected ray depend on the thickness of the layer.

Lastly, the disclosure also relates to a system making it possible to implement a method as described above.

Thus, the disclosure relates to a system for determining the characteristics of at least one layer of a multilayer polymer product, comprising:
a support table for advancing a multilayer polymer product,
a terahertz sensor,
means for acquisition and analysis of a signal reflected by the polymer product,
means for determining the temperature of a layer of the multilayer material on the basis of the analysis of the reflected signal.

In a preferred embodiment, the system further comprises means for determining the thickness of a layer of the material on the basis of the analysis of the reflected signal.

### BRIEF DESCRIPTION OF THE DRAWINGS

Further advantages and embodiments of the present disclosure will emerge from the description, which is non-limiting, of the various illustrative figures, in which:

FIG. 1 shows a system for implementing a method according to the disclosure,

FIG. 2 schematically shows the impact of terahertz radiation on a multilayer product,

FIG. 3 shows the raw and processed signal resulting from acquisition by a terahertz sensor implemented in the disclosure.

### DESCRIPTION OF EMBODIMENTS

In an example of an embodiment of a method according to the disclosure, illustrated in FIG. 1, a multilayer product 101 is positioned on a support table 102. This table is provided with means allowing the product to advance in the direction X. The table is surmounted by a frame on which is arranged a terahertz sensor 103. The speed of advance of the product is set according to the acquisition speed of the terahertz sensor. It is preferably between 10 and 70 meters per minute.

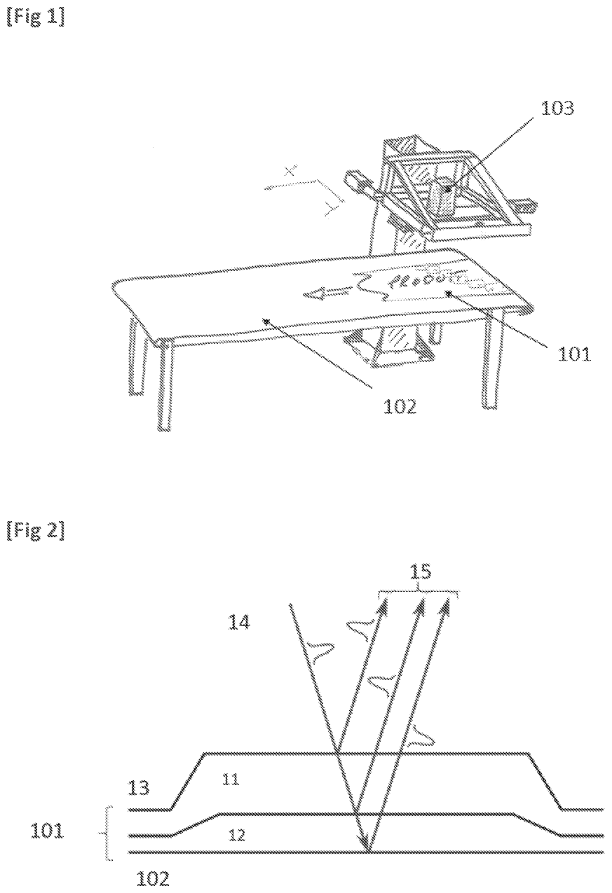

FIG. 2 schematically shows a product 1 comprising two layers 11 and 12 respectively forming media having different refractive indices, n1 and n2. This product 1 is placed on a support 102 (corresponding to the table 102 in the previous figure) having a refractive index which is different again, and the upper surface of the layer 11 is in contact with the ambient air 13.

When the terahertz sensor emits radiation, an incident THz ray reaches the product 1. This product in fact has three interfaces: an interface between the air and the layer 11, an interface between the layer 11 and the layer 12, and an interface between the layer 12 and the support 102.

When the incident THz pulse 14 passes through an interface, a fraction of the pulse is reflected. Thus, when the THz pulse propagates in the multilayer product, a series of pulses 15 is reflected.

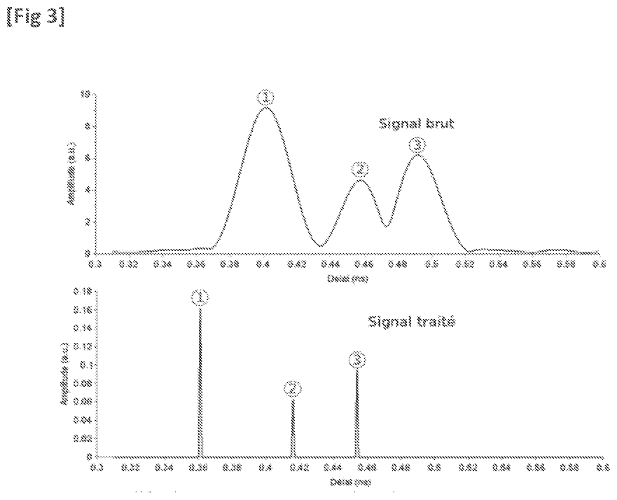

FIG. 3 shows the shape of the signal representing a series of pulses acquired on a product comprising two layers of rubber material.

The top curve shows the raw signal, and the bottom curve shows the signal after pre-processing, which is carried out to aid analysis.

It is known that the delay between two consecutive pulses is directly proportional to the thickness of material passed through. The calculation of the thickness of a layer on the basis of the delay between two consecutive pulses is performed using the real part of the refractive index. This number, which is characteristic of the material making up the layer, represents the speed of propagation of the THz pulse therein. Thus, on the processed signal shown in FIG. 3, the thickness of the layer 11 is determined by measuring the time lag between peak 1 and peak 2, and the thickness of the layer 12 is determined by measuring the time lag between peak 2 and peak 3.

What is claimed is:

1. A method for determining the temperature of at least one layer of a multilayer polymer product, the method comprising the following steps:
positioning the product to be measured on a transport table,
advancing the product under a frame comprising at least one terahertz sensor,
emitting incident terahertz radiation in the direction of the product,
detecting the signal corresponding to a series of pulses reflected by the interfaces encountered by the incident ray,
analyzing the signal to determine various peaks corresponding to the various interfaces encountered, and
determining, on the basis of the amplitude of each peak, the temperature of each layer of material through which the incident ray passes.

2. The method according to claim 1, wherein the multilayer polymer product is a product made up of several layers of rubber material, before or after curing.

3. The method according to claim 2, wherein the product is a tire, a caterpillar track or a conveyor belt.

4. The method according to claim 1, comprising a step of processing the raw signal before the analysis step.

5. The method according to claim 1, wherein the speed at which the product advances is between 0 and 70 meters per minute.

6. The method according to claim 1, wherein the acquisition rate of the terahertz sensor is greater than 100 Hz.

7. The method according to claim 1, and further comprising a step of determining, as a function of the difference between two peaks of the signal, the thickness of each layer of material through which the incident ray passes.

8. A system for determining the characteristics of at least one layer of a multilayer polymer product, comprising:
a support table for advancing a multilayer polymer product,
a terahertz sensor,
a means for acquisition and analysis of a signal reflected by the polymer product, and
a means for implementing a method for determining the temperature of a layer of the multilayer material according to the method of claim 1.

9. The system according to claim 8, further comprising a means configured to determine a thickness of each layer of material through which the incident ray passes as a function of a difference between two peaks of the signal.
